(19) United States
(12) Patent Application Publication
(10) Pub. No.: US 2023/0122787 A1
(43) Pub. Date: Apr. 20, 2023

(54) SYSTEMS AND METHODS FOR OFFLOADING MACHINE COMPUTATION FROM A HOME APPLIANCE TO A REMOTE DEVICE

(71) Applicant: Haier US Appliance Solutions, Inc., Wilmington (DE)

(72) Inventors: Juan Manuel Huerta, Louisville, KY (US); Abdel Hamad, Louisville, KY (US); Jeremy Miller, Louisville, KY (US)

(21) Appl. No.: 17/502,307

(22) Filed: Oct. 15, 2021

(51) Int. Cl. H04L 12/28; H04W 4/02; H04W 4/80; G06N 3/02

(52) U.S. Cl. CPC H04L 12/2827; G06N 3/02; H04L 12/282; H04W 4/023; H04W 4/80; H04L 2012/285; H04L 2012/2841

(57) ABSTRACT

A method of operating a home appliance includes generating raw data on the appliance, transmitting the raw data to a remote computing device, receiving a data analysis from the remote computing device, and implementing a responsive action based on the data analysis

### FIELD OF THE INVENTION

The present subject matter relates generally to home appliances, and more particularly to methods of operating home appliances requiring heavy computation.

### BACKGROUND OF THE INVENTION

Home appliances are increasingly becoming more interconnected, for instance, with each other and with internet connected devices. Further, home appliances are increasingly utilizing machine learning artificial intelligence to perform computations related to performance, options, maintenance, and the like. Generally, the computing power required to perform these computations is beyond what is typically installed in most home appliances. Accordingly, the information on which of these computations is performed may be sent to the cloud or a cloud computing server, where results are calculated and transmitted back to the appliance. In some cases, multi-access edge computing (MEC) is used to perform the calculations and computations.

These current methods have several drawbacks. For instance, repeatedly sending data to the cloud to perform calculations involves inherent security risks. By releasing sensitive information potentially unsecured networks, users may risk exposing themselves to malicious data attacks, resulting in failure of the home appliance or worse. Even having data encrypted may not result in total security. Further, additional costs are associated with transmitting information to cloud computing services, increasing the total operational cost of the home appliance, and placing further financial burden on the user. With respect to MEC, edge computers are typically not connected to the internet and thus would require routine updates via a third party connection, placing undue burden on the user.

Accordingly, a method for offloading machine computation to a remote device would be desirable. In particular, a method of utilizing nearby remote devices on contained networks would be useful.

### BRIEF DESCRIPTION OF THE INVENTION

Aspects and advantages of the invention will be set forth in part in the following description, or may be obvious from the description, or may be learned through practice of the invention.

In one exemplary aspect of the present disclosure, a method of performing intelligent determination on a home appliance is provided. The method may include receiving a trigger within the home appliance to generate a data packet; transmitting the data packet to a remote computing device via a remote connection; receiving a data analysis from the remote computing device; and implementing a responsive action on the home appliance based on the data analysis.

In another exemplary aspect of the present disclosure, a method of performing intelligent determination on a home appliance is disclosed. The method may include receiving a data packet on a remote computing device from the home appliance; performing a data analysis using an artificial intelligence neural network on the data packet; and transmitting the data analysis from the remote computing device to the home appliance.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 illustrates a connected network of appliances according to exemplary embodiments of the present disclosure.

FIG. 2 illustrates a workflow diagram of an example process for transmitting data according to exemplary embodiments of the present disclosure.

FIG. 3 illustrates a block diagram of an example hardware diagram for a platform run on a computing device according to exemplary embodiments of the present disclosure.

FIG. 4 illustrates a flowchart diagram of an example method for retrieving and processing consumer data according to exemplary embodiments of the present disclosure.

Repeat use of reference characters in the present specification and drawings is intended to represent the same or analogous features or elements of the present invention.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first,” “second,” and “third” may be used interchangeably to distinguish one component from another and are not intended to signify location or importance of the individual components. The terms “includes” and “including” are intended to be inclusive in a manner similar to the term “comprising.” Similarly, the term “or” is generally intended to be inclusive (i.e., “A or B” is intended to mean “A or B or both”). In addition, here and throughout the specification and claims, range limitations may be combined and/or interchanged. Such ranges are identified and include all the sub-ranges contained therein unless context or language indicates otherwise. For example, all ranges disclosed herein are inclusive of the endpoints, and the endpoints are independently combinable with each other. The singular forms “a,” “an,” and “the” include plural references unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin, i.e., including values within ten percent greater or less than the stated value. In this regard, for example, when used in the context of an angle or direction, such terms include within ten degrees greater or less than the stated angle or direction, e.g., “generally vertical” includes forming an angle of up to ten degrees in any direction, e.g., clockwise or counterclockwise, with the vertical direction V.

The word “exemplary” is used herein to mean “serving as an example, instance, or illustration.” In addition, references to “an embodiment” or “one embodiment” does not necessarily refer to the same embodiment, although it may. Any implementation described herein as “exemplary” or “an embodiment” is not necessarily to be construed as preferred or advantageous over other implementations. Moreover, each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

According to the present disclosure, systems and methods for transmitting data for computational analysis on a remote device are discussed. In detail, certain high level artificial intelligence learned models require heavy processing and computing capabilities. Remote (but geographically local) devices that already contain the required computing power can be used for faster and more efficient analyses. The remote devices may be internet connected, allowing for easy updates to the learned models. The remote devices may also contain a higher computing power as compared to the home appliance. The generated data analysis may then be transmitted back to the appliance for implementation.

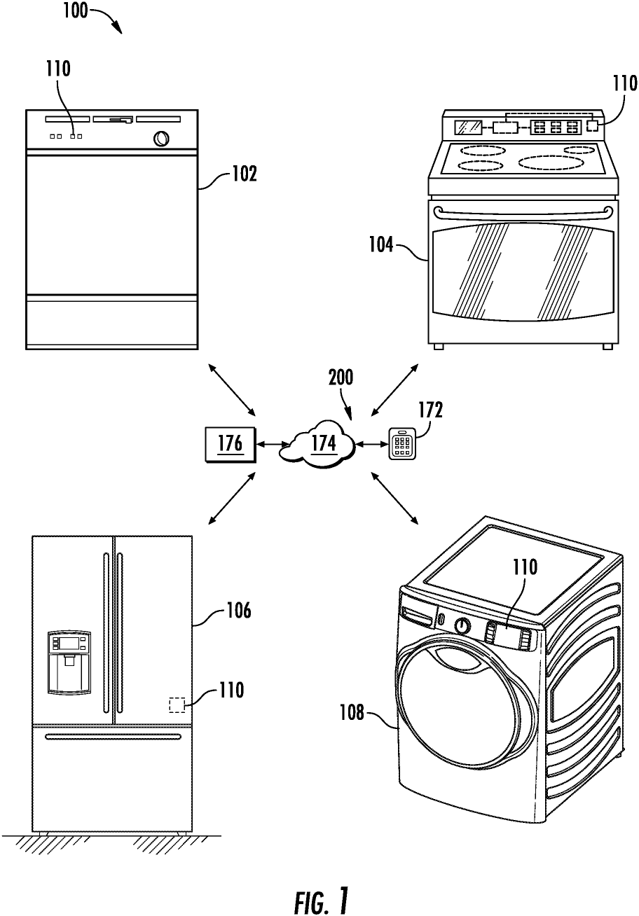

Referring to FIG. 1, a schematic diagram of an external communication system 200 will be described according to an exemplary embodiment of the present subject matter. In general, external communication system 200 is configured for permitting interaction, data transfer, and other communications between one or more appliances 100 and one or more external devices. For example, this communication may be used to provide and receive operating parameters, user instructions or notifications, performance characteristics, user preferences, or any other suitable information for improved performance of the one or more appliances 100. In addition, it should be appreciated that external communication system 200 may be used to transfer data or other information to improve performance of one or more external devices or appliances and/or improve user interaction with such devices.

For example, external communication system 200 permits controller 166 of at least one appliance 100 to communicate with a separate device external to the at least one appliance 100, referred to generally herein as an external device 172. As described in more detail below, these communications may be facilitated using a wired or wireless connection, such as via a network 174. In general, external device 172 may be any suitable device separate from the one or more appliances 100 that is configured to provide and/or receive communications, information, data, or commands from a user. In this regard, external device 172 may be, for example, a personal phone, a smartphone, a tablet, a laptop or personal computer, a wearable device, a smart home system, or another mobile or remote device.

In addition, a remote server 176 may be in communication with the one or more appliances 100 and/or external device 172 through network 174. In this regard, for example, remote server 176 may be a cloud-based server 176, and is thus located at a distant location, such as in a separate state, country, etc. According to an exemplary embodiment, external device 172 may communicate with a remote server 176 over network 174, such as the Internet, to transmit/receive data or information, provide user inputs, receive user notifications or instructions, interact with or control the one or more appliances 100, etc. In addition, external device 172 and remote server 176 may communicate with the one or more appliances 100 to communicate similar information.

In general, communication between the one or more appliances 100, external device 172, remote server 176, and/or other user devices or appliances may be carried using any type of wired or wireless connection and using any suitable type of communication network, non-limiting examples of which are provided below. For example, external device 172 may be in direct or indirect communication with the one or more appliances 100 through any suitable wired or wireless communication connections or interfaces, such as network 174. For example, network 174 may include one or more of a local area network (LAN), a wide area network (WAN), a personal area network (PAN), the Internet, a cellular network, any other suitable short- or long-range wireless networks, etc. In addition, communications may be transmitted using any suitable communications devices or protocols, such as via Wi-Fi®, Bluetooth®, Zigbee®, wireless radio, laser, infrared, Ethernet type devices and interfaces, etc. In addition, such communication may use a variety of communication protocols (e.g., TCP/IP, HTTP, SMTP, FTP), encodings or formats (e.g., HTML, XML), and/or protection schemes (e.g., VPN, secure HTTP, SSL).

External communication system 200 is described herein according to an exemplary embodiment of the present subject matter. However, it should be appreciated that the exemplary functions and configurations of external communication system 200 provided herein are used only as examples to facilitate description of aspects of the present subject matter. System configurations may vary, other communication devices may be used to communicate directly or indirectly with one or more associated appliances, other communication protocols and steps may be implemented, etc. These variations and modifications are contemplated as within the scope of the present subject matter.

Referring still to FIG. 1, a system of connected devices 100 according to exemplary embodiments of the present subject matter is illustrated. As shown, system of connected devices 100 generally includes a first appliance 102 (e.g., illustrated herein as a dishwashing appliance), a second appliance 104 (e.g., illustrated herein as an oven appliance), a third appliance 106 (e.g., illustrated herein as a refrigerator appliance), and a fourth appliance 108 (e.g., illustrated herein as a laundry appliance). Interaction between each of the first appliance 102 and the second appliance 104 will be described below according to exemplary embodiments of the present subject matter. However, it should be understood that the descriptions may apply to any and/or all of connected devices 100 shown. Further, it should be appreciated that the specific appliance types and configurations are only exemplary and are provided to facilitate discussion regarding the use and operation of an exemplary system of connected devices 100. The scope of the present subject matter is not limited to the number, type, and configurations of appliances set forth herein. Moreover, detailed descriptions of each particular appliance will be omitted for brevity.

For example, the system of connected appliances 100 may include any suitable number and type of “appliances,” such as “household appliances.” These terms are used herein to describe appliances typically used or intended for common domestic tasks, e.g., such as laundry appliances as illustrated in the figures. According to still other embodiments, these “appliances” may include but are not limited to a refrigerator, a dishwasher, a microwave oven, a cooktop, an oven, a washing machine, a dryer, a water heater, a water filter or purifier, an air conditioner, a space heater, and any other household appliance which performs similar functions in addition to network communication and data processing. Moreover, although only two appliances are illustrated, various embodiments of the present subject matter may also include three or more appliances, each of which may transmit, receive, and/or relay signals among connected appliances and/or other external devices.

As illustrated, each of first appliance 102, second appliance 104, remote user interface device 172, or any other devices or appliances in system of connected appliances 100 may include or be operably coupled to a controller, identified herein generally by reference numeral 110. As used herein, the terms “processing device,” “computing device,” “controller,” or the like may generally refer to any suitable processing device, such as a general or special purpose microprocessor, a microcontroller, an integrated circuit, an application specific integrated circuit (ASIC), a digital signal processor (DSP), a field-programmable gate array (FPGA), a logic device, one or more central processing units (CPUs), a graphics processing units (GPUs), processing units performing other specialized calculations, semiconductor devices, etc. In addition, these “controllers” are not necessarily restricted to a single element but may include any suitable number, type, and configuration of processing devices integrated in any suitable manner to facilitate appliance operation. Alternatively, controller 110 may be constructed without using a microprocessor, e.g., using a combination of discrete analog and/or digital logic circuitry (such as switches, amplifiers, integrators, comparators, flip-flops, AND/OR gates, and the like) to perform control functionality instead of relying upon software.

Controller 110 may include, or be associated with, one or more memory elements or non-transitory computer-readable storage mediums, such as RAM, ROM, EEPROM, EPROM, flash memory devices, magnetic disks, or other suitable memory devices (including combinations thereof). These memory devices may be a separate component from the processor or may be included onboard within the processor. In addition, these memory devices can store information and/or data accessible by the one or more processors, including instructions that can be executed by the one or more processors. It should be appreciated that the instructions can be software written in any suitable programming language or can be implemented in hardware. Additionally, or alternatively, the instructions can be executed logically and/or virtually using separate threads on one or more processors.

For example, controller 110 may be operable to execute programming instructions or micro-control code associated with an operating cycle of an appliance. In this regard, the instructions may be software or any set of instructions that when executed by the processing device, cause the processing device to perform operations, such as running one or more software applications, displaying a user interface, receiving user input, processing user input, etc. Moreover, it should be noted that controller 110 as disclosed herein is capable of and may be operable to perform any methods, method steps, or portions of methods as disclosed herein. For example, in some embodiments, methods disclosed herein may be embodied in programming instructions stored in the memory and executed by controller 110. The memory devices may also store data that can be retrieved, manipulated, created, or stored by the one or more processors or portions of controller 110. The data can include, for instance, data to facilitate performance of methods described herein. The data can be stored locally (e.g., on controller 110) in one or more databases and/or may be split up so that the data is stored in multiple locations. In addition, or alternatively, the one or more database(s) can be connected to controller 110 through any suitable communication module, communication lines, or network(s).

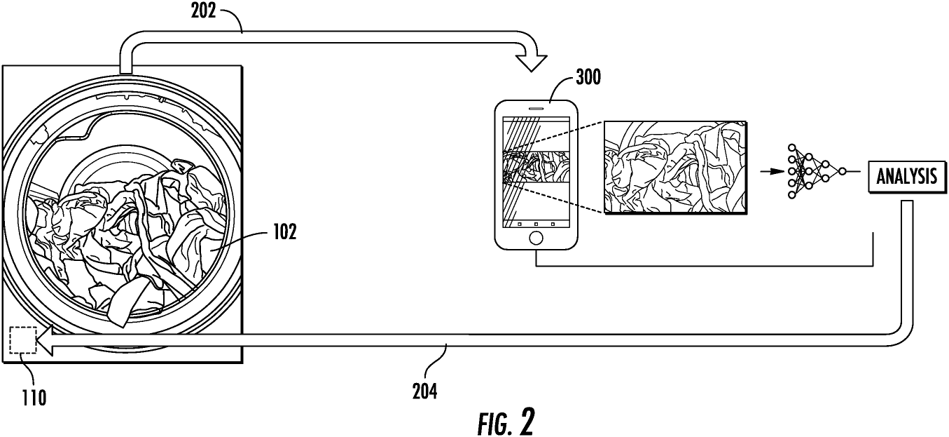

Referring to FIG. 2, an exemplary process of transmitting data from a home appliance (e.g., dishwashing appliance 102, oven appliance 104, etc.) to a remote computing device (e.g., external device 172, remote server 176, and/or other user devices or appliances) is illustrated. For this description, appliance 102 will be used as an example with the understanding that the description will apply to any and all appliances incorporated withing the system of connected appliances 100. Appliance 102 may include one or more instruments capable of producing data (e.g., raw data) 202. For example, appliance 102 includes at least one of a camera capable of capturing images of appliance 102 (e.g., an interior thereof), a microphone capable of capturing an audio signal generated by appliance 102 (e.g., an alarm, a knock, etc.), or a sensor configured to measure various attributes of appliance 102 (e.g., a temperature sensor, a humidity sensor, a pressure sensor, a door sensor, etc.). Some embodiments may include a combination of the above-mentioned instruments, and/or additional instruments.

The raw data 202 generated within appliance 102 and captured by the one or more instruments may include operational information relating to appliance 102. According to at least one example, the raw data 202 includes an image (e.g., photograph) of an interior of appliance 102. According to one example (e.g., when appliance 102 is a laundry appliance), the image captures a washing load within a wash drum of appliance 102. The photograph may include a tag (e.g., metadata) relating or referring to appliance 102 itself, such as a manufacturer’s model number or the like.

Additionally or alternatively, appliance 102 may require a model inference. In detail, the model inference may be a request for a task required for a performance characteristic or responsive action to be implemented by appliance 102. In some instances, a batch of raw data 202 may be generated by/within appliance 102. Thus, a relatively large amount of raw data 202 may be generated. The model inference may vary in scope, for instance, and may include such tasks as generative, predictive, clustering, anomaly detection, or the like. As will be explained in more detail below, the model inference may be run on a remote computing device and may generate a data analysis 204 (e.g., via embeddings).

In some implementations, one or more neural networks may be used to provide an embedding based on the raw data 202. For example, the embedding can be a representation of knowledge abstracted from the raw data 202 into one or more learned dimensions. In some instances, embeddings can be a useful source for identifying related entities (e.g., data points from raw data). In some instances, embeddings can be extracted from the output of the network, while in other instances embeddings can be extracted from any hidden node or layer of the network (e.g., a close to final but not final layer of the network). Embeddings may be useful for generating clusters of users, clusters of failure points, product suggestions, recipe suggestions, entity or object recognition, etc. In some instances, embeddings may be useful inputs for downstream models. For example, embeddings may be useful to generalize the raw data 202 (e.g., search queries) for a downstream model or processing system. In some implementations, the machine-learned (or machine learning) model can be used to preprocess the raw data 202 for subsequent input into another model. For example, the machine-learned model can perform dimensionality reduction techniques and embeddings (e.g., matrix factorization, principal components analysis, singular value decomposition, word2vec/GLOVE, and/or related approaches); clustering; and even classification and regression for downstream consumption.

In some implementations, the machine-learned model can perform various types of clustering. For example, the machine-learned model can identify one or more previously-defined clusters to which the input data most likely corresponds. As another example, the machine-learned model can identify one or more clusters within the raw data 202. That is, in instances in which the raw data 202 includes multiple objects, documents, or other entities, the machine-learned model may sort the multiple entities included in the raw data 202 into a number of clusters. In some implementations in which the machine-learned model performs clustering, the machine-learned model can be trained using unsupervised learning techniques. In some implementations, the machine-learned model may perform anomaly detection or outlier detection. For example, the machine-learned model may identify raw data 202 that does not conform to an expected pattern or other characteristic (e.g., as previously observed from previous data). As an example, the anomaly detection may be used for system failure detection.

In some implementations, the machine-learned model may receive and use the raw data 202 in its raw form. In some implementations, the raw data 202 can be preprocessed. Thus, in addition or alternatively to the raw data 202, the machine-learned model may receive and use the preprocessed data.

In some implementations, the machine-learned model may be or include one or more generative networks such as, for example, generative adversarial networks. Generative networks may be used to generate new data such as new images or other content.

In some implementations, the machine-learned model may be or include an autoencoder. In some instances, the aim of an autoencoder is to learn a representation (e.g., a lower-dimensional encoding) for a set of data, typically for the purpose of dimensionality reduction. For example, in some instances, an autoencoder may seek to encode the input data and then provide output data that reconstructs the raw data 202 from the encoding. Recently, the autoencoder concept has become more widely used for learning generative models of data. In some instances, the autoencoder can include additional losses beyond reconstructing the input data.

In some implementations, the machine-learned model may be or include one or more other forms of artificial neural networks such as, for example, deep Boltzmann machines; deep belief networks; stacked autoencoders; etc. Any of the neural networks described herein can be combined (e.g., stacked) to form more complex networks.

In some implementations, the input to the machine-learned model(s) of the present disclosure may be latent encoding data (e.g., a latent space representation of an input, etc.). The machine-learned model(s) may process the latent encoding data to generate an output. As an example, the machine-learned model(s) may process the latent encoding data to generate a recognition output. As another example, the machine-learned model(s) may process the latent encoding data to generate a reconstruction output. As another example, the machine-learned model(s) may process the latent encoding data to generate a search output. As another example, the machine-learned model(s) may process the latent encoding data to generate a reclustering output. As another example, the machine-learned model(s) may process the latent encoding data to generate a prediction output.

In some implementations, the input to the machine-learned model(s) of the present disclosure may be sensor data. The machine-learned model(s) may process the sensor data to generate an output. As an example, the machine-learned model(s) may process the sensor data to generate a recognition output. As another example, the machine-learned model(s) may process the sensor data to generate a prediction output. As another example, the machine-learned model(s) may process the sensor data to generate a classification output. As another example, the machine-learned model(s) may process the sensor data to generate a segmentation output. As another example, the machine-learned model(s) may process the sensor data to generate a segmentation output. As another example, the machine-learned model(s) may process the sensor data to generate a visualization output. As another example, the machine-learned model(s) may process the sensor data to generate a diagnostic output. As another example, the machine-learned model(s) may process the sensor data to generate a detection output.

Referring again to FIG. 2, appliance 102 may establish a connection (e.g., remote or wireless connection) with a remote computing device 300. According to at least some embodiments, remote computing device 300 may be or include external device 172. For this disclosure, the “remote” computing device may still be within the general vicinity of appliance 102 (e.g., within a about 100 to 200 feet) but may not be hardline connected to appliance 102. Thus, for purposes of this disclosure, the term “remote computing device” may refer to a geographically local computing device (e.g., within a domicile in which appliance 102 is provided). For instance, the remote computing device 300 may be a mobile device (e.g., mobile telephone or tablet), an appliance hub (e.g., a kitchen hub), a laptop computer, a desktop computer, or the like. In some embodiments, the remote connection is already established and active. Accordingly, appliance 102 may send a wake-up signal to the remote computing device 300 to receive the raw data. According to still other embodiments, multiple remote computing devices 300 may be near, active, and connected (or connectable) to appliance 102. In this case, appliance may establish the remote connection with each remote computing device 300. Additionally or alternatively, appliance 102 may determine a primary remote computing device 300 to which to transfer a majority of the raw data 202 for analysis. The raw data 202 may thus be split and distributed to each of the multiple remote computing devices 300, which may reduce the amount of required computing time.

The remote connection established between appliance 102 and the remote computing device 300 may vary depending on signal strength, proximity between appliance 102 and remote computing device 300, or any other restrictive factors. For instance, appliance 102 (e.g., via controller 110) may determine that remote computing device 300 is within a first predetermined distance from appliance 102. The first predetermined distance may be between about 10 feet and about 30 feet. Upon determining that remote computing device 300 is within the first predetermined distance, appliance 102 may initiate a short-range connection (e.g., Bluetooth®). Additionally or alternatively, appliance 102 may determine that remote computing device 300 is greater than the first predetermined distance away from appliance 102. Upon determining that remote computing device 300 is greater than the first predetermined distance away, appliance 102 may initiate a longer range connection (e.g., Wi-Fi®). It should be noted that any suitable remote connection may be established between appliance 102 and remote computing device 300.

In some implementations, remote computing device 300 may alert a user that appliance 102 is attempting to establish or perform the remote connection. For instance, a notification such as a pop-up notification may be presented (e.g., via a display on remote computing device 300) notifying the user of the potential connection. The pop-up notification may require the user to confirm the connection, e.g., by pressing an accept button. Accordingly, a confirmation signal may be sent to appliance 102 to proceed with the remote connection.

Remote computing device 300 may thus receive the raw data 202 and perform a data analysis 204. As described above, a neural network may be used in performing the data analysis 204. In detail, the remote computing device may include a mobile application configured to process, using a neural network, the raw data 202. In some instances, the raw data 202 (e.g., an image file as shown in FIG. 2) may be preprocessed by remote computing device 300. Using the artificial intelligence machine learned model described above, remote computing device 300 may perform an analysis on the preprocessed data and generate the data analysis 204. In response to receipt of the raw data 202 or preprocessed data, the machine learned model may provide the data analysis 204 (or output data). The output data may include different types, forms, or variations of output data. As examples, in various implementations, the output data may include one or more maps including clusters of similar embeddings, thus resulting in ideal settings for particular operations. In some embodiments, the data analysis 204 is converted into a readable (e.g., machine-readable) text file (or .txt file).

In some implementations, the data analysis 204 (or output data) may include predictions. For example, the machine learned model may process the raw data 202 related to failures of related home appliances (e.g., failure of a refrigeration coil of a refrigerator appliance). Upon determining that the new home appliance is near a cluster that exhibits a particular failure point, the machine-learned model may predict a failure point of the new home appliance. Accordingly, the new user may be notified as to a potential failure. Additionally or alternatively, one or more repair technicians may be alerted as to the potential for failure, and appropriate diagnostic action may be taken. In some instances, a repair call may be scheduled automatically in prediction of a failure. Additionally or alternatively, repair items may be ordered, or a prompt may be sent to the user to order repair items. It should be noted that the embodiments described herein are not limited to the examples discussed above, and that the machine-learned model may process and sort users and/or new appliances according to any suitable metrics.

Upon performing the analysis and generating the data analysis 204, the remote computing device (or remote computing devices) 300 may transmit the data analysis 204 back to appliance 102 (e.g., as the machine-readable file). Appliance 102 may thus receive the data analysis 204 and implement the results. For instance, when the data analysis 204 includes a determination of a type of wash load within a laundry appliance, appliance 102 (in this case the laundry appliance) may initiate a washing operation best suited for the determined wash load. In another example, the data analysis 204 may contain instructions to implement a predetermined washing operation (e.g., as determined by the machine learned model).

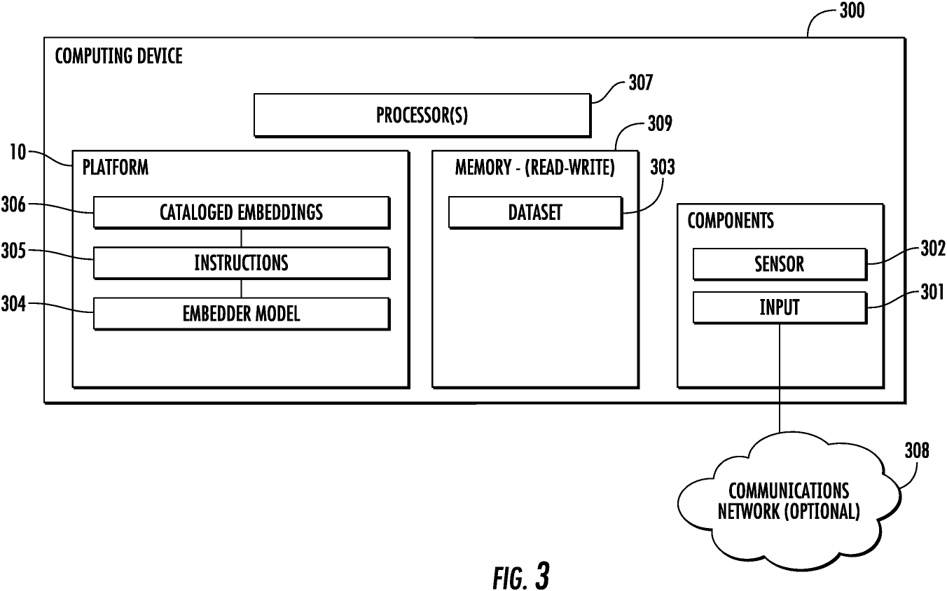

FIG. 3 illustrates an example hardware diagram for a platform 10 run on a computing device (e.g., remote computing device 300). In some embodiments, the computing device is provided in or on mobile device 172. The computing device may include one or more processors 307 that can execute computer readable instructions 305 for utilizing components that include, for example, a sensor 302 and an input (e.g., button, knob, selector, camera, microphone, etc.) 301. Examples of these instructions include methods for retrieving a dataset 303, processing the dataset 303 using an embedder model 304, and accessing cataloged embeddings 306. In some embodiments, a communications network 308 (e.g., similar to or different from external communications system 200 described above) may provide a conduit for the computing device to receive the dataset 303. Generally, computing devices may include smartphones, tablets, laptops, and desktop computers, as well as other locally or remotely connected devices (e.g., mobile device 172) which could be capable of interacting with a communications network 308. As an example, the computing device may include a smart phone containing a processor 307 as well as the platform 10 as a downloaded application. Upon receiving the raw data from, e.g., appliance 102, the raw data may be preprocessed or used as is. The smartphone may access the platform 10 as an application to run the instructions for receiving the raw data and processing the raw data to generate an embedding. In some computing devices, the platform may perform these steps automatically after the sensor is triggered or any time the input is used.

Embodiments of the disclosure may include training systems on the computing device or that can be accessed through the communications network 308. The training computing system may include one or more processors 307 and a memory 309. The one or more processors 307 may be any suitable processing device (e.g., a processor core, a microprocessor, an ASIC, a FPGA, a controller, a microcontroller, etc.) and may be one processor or a plurality of processors that are operatively connected. The memory 309 may include one or more non-transitory computer-readable storage mediums, such as RAM, ROM, EEPROM, EPROM, flash memory devices, magnetic disks, etc., and combinations thereof. The platform 10 may include instructions 305 which are executed by the processor 307 to cause the training computing system to perform operations. In some implementations, the training computing system includes or is otherwise implemented by one or more server computing devices.

The model trainer may include computer logic utilized to provide desired functionality. The model trainer may be implemented in hardware, firmware, and/or software controlling a general purpose processor. For example, in some implementations, the model trainer includes program files stored on a storage device, loaded into a memory and executed by one or more processors. In other implementations, the model trainer includes one or more sets of computer-executable instructions that are stored in a tangible computer-readable storage medium such as RAM hard disk or optical or magnetic media.

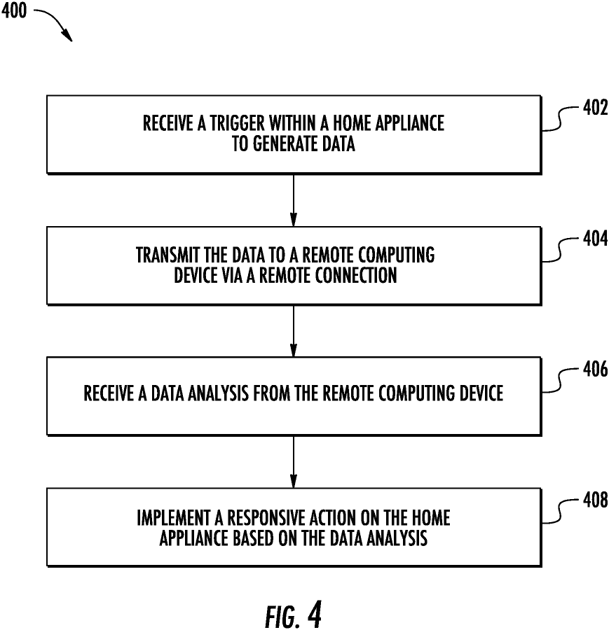

Referring now to FIG. 4, an exemplary method of operating an appliance (e.g., appliance 102) will be described. At step 402, method 400 may include receiving a trigger within a home appliance to generate data. As described above, the appliance may include one or more instruments configured to generate data, such as a camera, a microphone, sensors, or the like. In this instance, the trigger may include an input from a user. For example, the input can be loading items to be washed into a laundry appliance (or dishwashing appliance), inserting items into a refrigerator appliance, placing food items to be cooked into an oven appliance, etc. A controller within the appliance may recognize the trigger as an inference or information request and activate the one or more instruments configured to gather data. The amount of data generated or gathered may vary according to the input trigger. Further, the data may be preprocessed on the appliance, on an intermediary device, or on a remote computing device.

At step 404, method 400 may include transmitting the data (e.g., such as raw data 202 described above with respect to FIG. 2) to a remote computing device via a remote connection. The appliance may confirm that a remote connection has been established between itself and the remote computing device or may initiate the connection. In some embodiments, the appliance determines that multiple remote computing devices are in the vicinity and may establish the remote connection with each device. Once the connection is established and the appliance is communicating with the one or more remote computing devices, the appliance may transmit the raw data (or preprocessed data) to the one or more remote computing devices. Further, as described above, the remote connection may be one or more of a short-range connection and a longer range connection.

At step 406, method 400 may include receiving a data analysis (e.g., such as data analysis 204 described above with respect to FIG. 2) from the remote computing device. As described above, the remote computing device (or multiple remote computing devices) may perform the data analysis (e.g., via a neural network trained model). Upon generating the data analysis, the remote computing device may return the data analysis to the appliance (e.g., via the remote connection). The data analysis may be converted into a machine-readable form before being returned to the appliance.

At step 408, method 400 may include implementing a responsive action on the appliance based on the data analysis. As described above, the data analysis may include information or instructions for performing an operation on the appliance, such as a washing or cooking operation. In some embodiments, the data analysis includes a generated shopping list (e.g., from an image taken of the inside of a refrigerator appliance). It should be understood that myriad responsive actions may be determined from the data analysis depending on the home appliance requesting the data analysis, and the disclosure is not limited to the examples discussed herein.

In any of the above embodiments, the system may receive the data points from multiple users and process the dataset using an embedding model to generate the embedding for the data point. As an example embodiment, the embedding model may be an artificial neural network such as, for example, a convolutional neural network. The embedding model may be trained (e.g., via a triplet training scheme) to produce embeddings for objects in an embedding dimensional space, where a magnitude of a distance between two embeddings for two objects is inversely correlated with a similarity between the two objects. In some embodiments, the platform may include a single embedding model while in other embodiments multiple different embedding models can be used. For example, different embedding models may be used which are respectively trained to be specific to different types, domains, or classes of objects. As one example, the platform may use a first embedding model for general objects but a second, specialized embedding model for food or food dishes.

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

In addition, the machine learning techniques described herein are readily interchangeable and combinable. Although certain example techniques have been described, many others exist and can be used in conjunction with aspects of the present disclosure.

Thus, while the present subject matter has been described in detail with respect to various specific example implementations, each example is provided by way of explanation, not limitation of the disclosure. One of ordinary skill in the art can readily make alterations to, variations of, and equivalents to such implementations. Accordingly, the subject disclosure does not preclude inclusion of such modifications, variations and/or additions to the present subject matter as would be readily apparent to one of ordinary skill in the art. For instance, features illustrated or described as part of one implementation can be used with another implementation to yield a still further implementation.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A method of performing intelligent determination on a home appliance, the method comprising:
receiving a trigger within the home appliance to generate a data packet;
transmitting the data packet to a remote computing device via a remote connection;
receiving a data analysis from the remote computing device; and
implementing a responsive action on the home appliance based on the data analysis.

2. The method of claim 1, further comprising:
establishing the remote connection between the home appliance and the remote computing device in response to receiving the trigger, the remote computing device being located within a predetermined radius from the home appliance.

3. The method of claim 2, wherein the data packet comprises at least one of an image or an audio recording.

4. The method of claim 2, wherein the remote computing device comprises a plurality of remote computing devices, the method further comprising:
determining that each of the plurality of remote computing devices is within a connectable range in response to receiving the trigger;
establishing a connection with each of the plurality of remote computing devices; and
transmitting at least a portion of the data packet to each of the plurality of remote computing devices.

5. The method of claim 2, wherein the remote computing device is an internet connected mobile device.

6. The method of claim 5, wherein the internet connected mobile device comprises a mobile application configured to process, using a neural network, the data packet to generate the data analysis.

7. The method of claim 6, wherein the data analysis comprises a computer readable file of instructions regarding operation of the home appliance.

8. The method of claim 6, further comprising:
alerting a user that the home appliance is performing the remote connection with the remote computing device in response to receiving the trigger; and
receiving a confirmation signal from the user to perform the remote connection with the remote computing device.

9. The method of claim 8, further comprising:
determining that the remote computing device is within a first predetermined distance from the home appliance; and
establishing the remote connection as a first remote connection, the first remote connection being a Bluetooth connection.

10. The method of claim 9, further comprising:
determining that the remote computing device is greater than the first predetermined distance from the home appliance; and
establishing the remote connection as a second remote connection, the second remote connection being a wireless network connection.

11. A method of performing intelligent determination on a home appliance, the method comprising:
receiving a data packet on a remote computing device from the home appliance;
performing a data analysis using an artificial intelligence neural network on the data packet; and
transmitting the data analysis from the remote computing device to the home appliance.

12. The method of claim 1, further comprising:
establishing a remote connection between the home appliance and the remote computing device in response to receiving the trigger, the remote computing device being located within a predetermined radius from the home appliance.

13. The method of claim 12, wherein the data packet comprises at least one of an image or an audio recording.

14. The method of claim 12, wherein the remote computing device comprises a plurality of remote computing devices, the method further comprising:
determining that each of the plurality of remote computing devices is within a connectable range prior to receiving the data packet from the home appliance;
establishing the remote connection with each of the plurality of remote computing devices; and
transmitting at least a portion of the data packet to each of the plurality of remote computing devices.

15. The method of claim 12, wherein the remote computing device is an internet connected mobile device.

16. The method of claim 15, wherein the internet connected mobile device comprises a mobile application configured to process, using a neural network, the data packet to generate the data analysis.

17. The method of claim 16, wherein the data analysis comprises a computer readable file of instructions regarding operation of the home appliance.

18. The method of claim 16, further comprising:
alerting a user that the home appliance is performing the remote connection with the remote computing device in response to receiving the trigger; and
receiving a confirmation signal from the user to perform the remote connection with the remote computing device.

19. The method of claim 18, further comprising:
determining that the remote computing device is within a first predetermined distance from the home appliance; and
establishing the remote connection as a first remote connection, the first remote connection being a Bluetooth connection.

20. The method of claim 19, further comprising:
determining that the remote computing device is greater than the first predetermined distance from the home appliance; and
establishing the remote connection as a second remote connection, the second remote connection being a wireless network connection.
